(19) United States
(12) Patent Application Publication
(10) Pub. No.: US 2009/0033458 A1
(43) Pub. Date: Feb. 5, 2009

(54) Integrated apparatus for the control of the accesses

(75) Inventor: Elviro Mario Govoni, Ferrara (IT)

Correspondence Address: THE WEBB LAW FIRM, P.C., 700 KOPPERS BUILDING, 436 SEVENTH AVENUE, PITTSBURGH, PA, 15219, US

(73) Assignee: Prastel S.P.A., Bologna (IT)

(21) Appl. No.: 11/888,083

(22) Filed: Jul. 31, 2007

(51) Int. Cl. G05B 19/00

(52) U.S. Cl. 340/5.7

(57) ABSTRACT

The invention relates to an integrated apparatus for the control of accesses, which can be used, in particular, coupled with an automated opening system for doors, main doors, gates and the like, wherein it comprises a single support element on which are disposed a section for the control of accesses and a section for the drive of the automated system.

### FIELD OF THE INVENTION

The present invention relates to an integrated apparatus for the control of the accesses.

The apparatus is usable, in particular, for the control of an automated closing system disposed and acting, for example, in correspondence of doors, main doors, gates, door and window frames, and the like.

### BACKGROUND OF THE INVENTION

Aim of the present invention is to provide with an integrated apparatus for the control of the accesses which can enable the opening of an automated opening system on the base of the data stored in a identification device, that is a mobile support provided with a memory containing data which can be identified by a relevant reader. Usually, said mobile support is a magnetic card, a proximity card/tag or a similar device.

### SUMMARY OF THE INVENTION

In particular, according to the invention, the apparatus is provided, in a single body, with a section suitable for controlling the accesses and with a section suitable for driving the automated opening system.

This result has been achieved according to the invention thanks to the idea of an apparatus having the features described in the independent claim. Other features relate to the dependant claims.

Among the advantages of the present invention there is that the apparatus allows, by installing a single apparatus, both the control of the accesses and the driving of the opening system, the driving of the opening system being subordinate to the reading of a correspondent identification device; with the present invention it is possible therefore to personalize the modalities of access of each customer on the basis of the data introduced by the corresponding identification device, with an extreme simplification in phase of installation and maintenance.

### BRIEF DESCRIPTION OF THE DRAWINGS

A non-limiting embodiment of the present invention will be described by way of example with reference to the accompanying drawing, wherein:

FIG. 1 is a schematic perspective view, with hidden parts, of a possible embodiment of an apparatus according to the invention;

FIG. 2 is a schematic plan view of the example of FIG. 1;

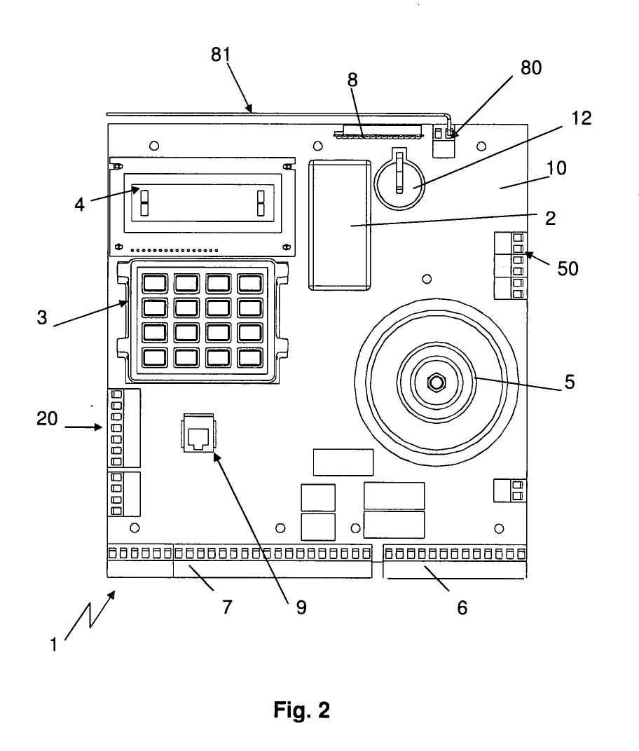

FIG. 3 is a block diagram relevant to a possible embodiment of the invention.

### DESCRIPTION OF A PREFERRED EMBODIMENT

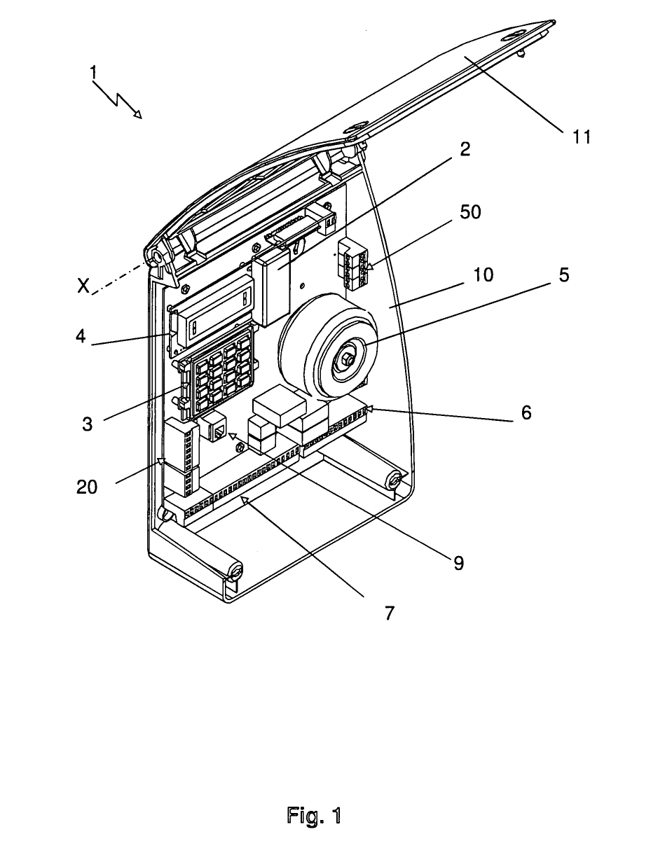

With reference to the enclosed drawings, an apparatus (1) according to the invention comprises a single support element (10) provided with a section for controlling the accesses and with a section for driving an automated opening system. In particular, the support element (10) is box shaped and is provided with a relative cover (11), which is hinged in correspondence of a horizontal axis (x). In the example of FIG. 1 a side portion (on left) of the box shaped body of the support element is removed. A reader (2) for an identification device is inside the support element (1). Advantageously, the reader (2) can be of the type known as proximity reader, that is a device which can identify, in a determined area, the data stored in a correspondent identification device. The identification device can be, for example, a badge, a proximity tag, etc.

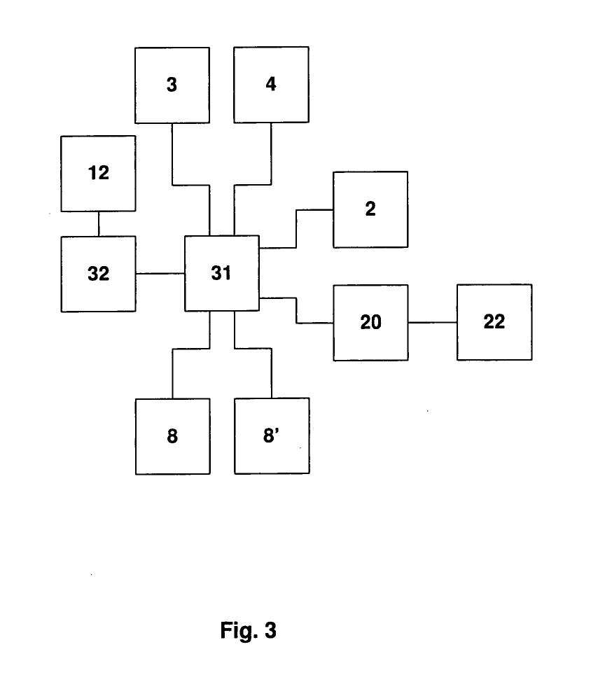

The apparatus (1) can be provided, as in the example, with connecting elements (20) to other readers for identification devices. In other words, the reader (2), which is physically disposed on the support (10), is used for enabling identification devices, while one or more additional readers, which are connected to the apparatus by means of the connectors (20), are employed for the driving of the automated opening system, said additional readers being only schematically represented by the block 22 in FIG. 3. Such additional readers can be, for example, RF or IR receivers, proximity readers, magnetic strip readers, microwaves readers, etc.

The reader (2) is connected to an elaborating unit (computer) which can comprise at least a microcontroller (represented by the block 31 in FIG. 3) and at least a memory (represented only schematically by the block 32 in FIG. 3). The memory (32) is of not volatile type or provided with a buffer battery (12) and it can be suitably programmed by means of a keyboard (3), provided with a relevant display (4).

The apparatus can be fed by means of a transformer (5), connectable to an electrical system by means of connectors (50). There is a buffer battery (12) for the memory (32) of microcontroller (31).

On the support element (10) are disposed, moreover, a first group of connectors (6), to which the motors of the automated opening systems are connectable, and a second group of connectors (7), usable for the connection to accessory devices, which can be photoelectric cell detectors, courtesy lights, luminous and/or acoustic signalling device, etc.

In the example, the apparatus (1) is provided with a radio receiving section (8), which is provided with a connector (80) for an antenna (81). The radio receiving section (8) is connected to the microcontroller (31) so to send to this latter the received signals.

The radio section (8) can receive radio signals suitably codified by transmission means, with the function of anti-panic alarm, and can signal the received alarm to a remote station by means of a communication, for example of serial type.

With reference to the example of FIG. 3, the apparatus (1) is provided with an additional radio receiver (8′) which can utilize signals coming from anti-intrusion devices or safety devices which operate by transmitting via radio their state.

The apparatus (1) can be provided with inputs, for example in correspondence of said connectors (20), for allowing the connection of alarms whose activation is signalled to a remote station through a communication, as an example of serial type.

In order to allow the management of the received signals, the apparatus (1) is provided with electronic elaboration means able to recognize the received signals and to activate, consequently, other devices, also remote. Such means of elaboration can be the same microcontroller (31) or other microcontrollers directly or indirectly connected to the first one.

The microcontroller (31) is connectable, moreover, to a personal computer by means of a suitable communication port (9), or, through the same communication port, to an independent programming unit suitable to execute all the functions of management of the accesses.

In phase of installation, when the support (10) is fixed to a wall or other fixed structure, it is sufficient to execute the connections with the connectors in order to obtain a control of the accesses suitable to enabling the opening of a passage.

In other words, with an extreme facility and by means of the installation of a single apparatus (1), it is possible to couple to each user the corresponding data relevant to the access timetables, to the type of access, etc.

The programming of the data can be realized, according to the choices of the installer, locally, by means of the keyboard (3) and the display (4), or at distance (remote), by means of a personal computer or independent programming unit.

Some of the control devices of the elements described above, which are shown in the enclosed drawings, are known to the technicians of this field and, for this, reason, they have not been described in detail in order to simplify their explanation.

Moreover, the execution details may vary as regards the shape the size, the arrangement of the elements, the kind of material used, but they are within the limits of the solution adopted and within the limits of the protection offered by the present patent.

1-11. (canceled)

12. An integrated apparatus for the control of accesses, wherein the apparatus is adapted to be coupled with an automated opening system for doors, main doors, or gates, wherein the apparatus comprises a single support element having disposed thereon a section for access control and a section for drive control of the automated system.

13. The integrated apparatus of claim 12, further comprising a reader for local user identification devices.

14. The integrated apparatus for claim 12, further comprising a processing unit with a storage memory programmable for coupling a code received from an identification access device with relevant validations for driving of the automated opening system.

15. The integrated apparatus of claim 12, further comprising radio-connecting means for receiving codes enabled for utilizing the automated opening system.

16. The integrated apparatus of claim 12, further comprising connecting means to one or more motors of the automated opening system.

17. The integrated apparatus of claim 12, further comprising connecting means to one or more readers for user identification devices.

18. The integrated apparatus of claim 12, further comprising means for:
receiving coded radio; and
receiving an anti-panic alarm and transmitting a corresponding signal to a remote station by serial communication means.

19. The integrated apparatus of claim 12, further comprising a radio receiver configured to manage signals transmitted from anti-intrusion or safety devices transmitting a state thereof via radio transmission.

20. The integrated apparatus of claim 12, further comprising inputs for connecting a bell alarm, wherein the integrated apparatus is configured to signal the activation of the bell alarm to a remote station.

21. The integrated apparatus of claim 12, further comprising means for connecting to a telecommunication line.

22. The integrated apparatus of claim 12, wherein said support element is box-shaped and is provided with a cover.
